(19) United States
(12) Patent Application Publication
(10) Pub. No.: US 2009/0165009 A1
(43) Pub. Date: Jun. 25, 2009

(54) OPTIMAL SCHEDULING FOR CAD ARCHITECTURE

(75) Inventors: Patrick Bernard Heffernan, Los Gatos, CA (US); Heidi Daoxian Zhang, Los Gatos, CA (US)

Correspondence Address: Three Palm Software LLC, 367 Penn Way, Los Gatos, CA, 95032, US

(73) Assignee: THREE PALM SOFTWARE, Los Gatos, CA (US)

(21) Appl. No.: 12/335,344

(22) Filed: Dec. 15, 2008

Related U.S. Application Data
(60) Provisional application No. 61/008,073, filed on Dec. 19, 2007.

(51) Int. Cl. G06F 9/46

(52) U.S. Cl. 718/103

(57) ABSTRACT

A system and method for optimal scheduling of image processing jobs is provided. Requests for processing originate either from a DICOM service that receives images sent to the system, and forwards those for batch processing, or from an interactive workstation application, which requests interactive CAD processing. Each request is placed onto a queue which is sorted first by priority, and second by the time that the request is added to the queue. Requests for interactive processing from a workstation application are added to the queue with the highest priority, whereas requests for batch processing are added at a low priority. The algorithm service takes the top-most item from the queue and passes the request to the algorithms which it hosts, and when that processing is completed, it sends a message to one or more output queues.

### CROSS-REFERENCE TO RELATED APPLICATIONS

### U.S. Patent Documents

1. Patent application U.S. Ser. No. 11/440,978 “DICOM adapter service for CAD system”, May 25, 2006.

### Other Publications

2. Patrick Heffernan and Heidi Zhang, “Software architecture for a CAD server”, CARS, International Congress Series 168 (2004), pages 861-866, 2004.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable

### BACKGROUND OF THE INVENTION

The present invention relates generally to the field of medical imaging systems. Particularly, the present invention relates to a method and system for optimal scheduling of image processing jobs in conjunction with off-line batch preprocessing and online on-demand processing tasks for computer-aided detection, review and diagnosis (CAD) workstation devices.

The U.S. patent Classification Definitions: 382/128 (class 382, Image Analysis, subclass 128, Biomedical application).

Prior art that discusses a similar subject to that considered here can be found in references 1 and 2. The systems described in those documents receives a “case” as a sequence of DICOM images, applies CAD processing to the entire “case”, and sends out a CAD report for that case. The “case-level” model of the system does not handle finer granularity of the process work. Therefore it can not meet the needs of interactive image processing tasks.

### BRIEF SUMMARY OF THE INVENTION

The system described here addresses the issues in prior arts in that the unit of work is an image (not a complete case), and the architecture described here is finer grained, allowing a mechanism for multiple priority streams of processing. This in turn allows for both interactive and batch processing within the same implementation, as opposed to the strictly off-line model described in references 1 and 2. Thus an essential difference between the present invention and prior art is its capability to meet the needs of interactive applications.

The present invention considers two types of imaging processing: opportunistic off-line preprocessing and interactive online processing. In a CAD workstation system, it is usually desirable to preprocess the images to generate automated findings from the images, such as, anatomy segmentations, and computer-aided cancer detection reports. When the system is used interactively by a user, further on-demand image processing is requested, and the result is required in real-time (i.e., interactively). An example of such online interactive image processing is lesion segmentation and assessment of a finding that is manually detected by the user. Existing CAD systems and workstations do not handle these two types of image processing tasks together in an optimal fashion.

### BRIEF DESCRIPTIONS OF THE DRAWINGS

FIG. 1 illustrates the use of a CAD system when cases are pushed to the system by a remote entity; the images are stored locally, and subsequently processed by a CAD algorithm, with the resultant CAD report exported as DICOM once the processing is completed. In the model described here, there can be multiple overlapped (in time) data sources, and the messages in the queue sent to the Algorithm Service are at the granularity of a message per source image, allowing for processing of a case while further images in that case are being received by the DICOM Service.

FIG. 2 further illustrates the granularity of messages exchanged between the DICOM Service and the Algorithm Service—each entry in the queue corresponds to a request to process a single image. Each request has an associated time-stamp (when it was added to the queue), and a priority, which is a means for the system to differentiate between batch processing (low priority) and interactive (high priority) tasks. Note that the “Requestor” need not be the DICOM Service—it can be another application, in particular for interactive tasks, the requester will be an interactive application which has a need for interactive CAD processing.

### DETAILED DESCRIPTION OF THE INVENTION

A system and method for optimal scheduling of image processing jobs is provided. The system comprises an algorithm service that hosts both off-line batch algorithm preprocessing tasks and online on-demand algorithm processing tasks for computer-aided detection, review and diagnosis (CAD) workstation devices. Requests for processing come either from a DICOM service that receives images sent to the system, and forwards those for batch processing, or from an interactive workstation application, which requests interactive CAD processing. In order to support both behaviors, requests for processing are placed onto a queue which is sorted first by priority, and second by the time that the request is added to the queue. Requests for interactive processing from a workstation application are added to the queue with the highest priority, whereas requests for batch processing are added at a low priority. The algorithm service accepts and processes requests for computation from a single input queue. Cyclically until the queue is empty, it takes the top-most item from the queue and passes the request to the algorithms which it hosts, and when that request is completed, it sends a message to one or more output queues. In this way, low-priority batch processing requests are processed opportunistically whenever the computer is not processing a high-priority interactive processing task. Similarly, low priority batch processing tasks can be preempted prior to completion, if a high-priority interactive request is received on the input queue.

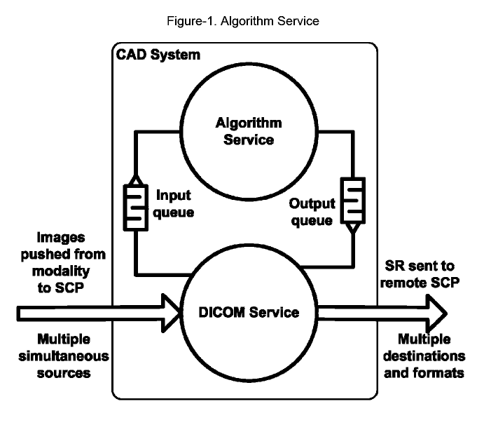

FIG. 1. Batch processing model for CAD: this diagram illustrates a “legacy” model (where source data is pushed to the CAD system, and generated reports are pushed to configured destinations). The same architecture can support alternate batch processing models (such as the IHE post-processing workflow). This architecture is comprised of the following major building blocks:

CAD algorithm—the code that performs the image specific processing. This code is hosted by the “algorithm service”, and is given a set of images to process, and it generates a set of reports (the CAD results).

Algorithm service—this is a windows service that is installed on a hosting computer. It is configured to start on system startup, and runs in the background, accepting requests for computation from an “input queue” and passing them to algorithm(s) it hosts, and when those are completed, it sends a message to one or more “output queues”.

DICOM service—this is another windows service that is installed on the hosting computer. The algorithm service and DICOM service can be installed on the same computer, but the architecture supports other combinations (including models where there is no DICOM service—the initiator of CAD processing can be any software that can send a message to the input queue). The DICOM service essentially operates as a configurable DICOM router—it listens for associations, and in the simplest model provides a storage class provider for DICOM images that are pushed to it. On receipt of such images, it stores them to disk (typically in DICOM “part-10” format), and sends a request to the algorithm service (via the input queue) to process that case. Once the CAD processing is completed, the DICOM service receives a message from the “output queue”, and uses this to trigger the conversion of the CAD report into an export stream (typically DICOM SR) which is sent to configured destinations.

Supporting services—FIG. 1 shows two queues, which are implemented using MSMQ (so using operating system support). Status information which ties input jobs to returned output is also maintained by the system. Given that the architecture can be distributed across multiple computers, this repository is implemented as another service (called a “procedure log”), and installed as another Windows service on a hosting computer.

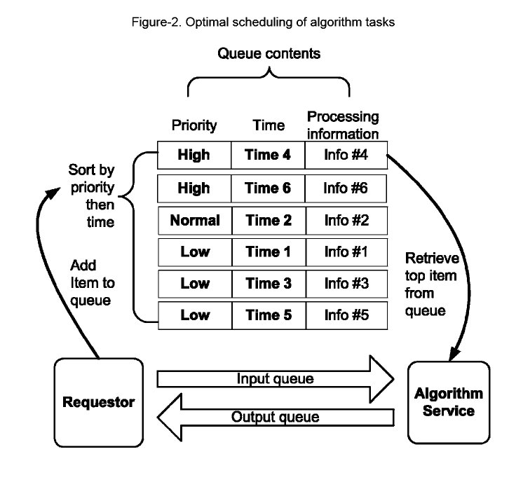

Interactive CAD processing fits into the architecture at the level of the queues (see FIG. 2). For batch processing tasks, the requestor is the DICOM service. For interactive processing tasks, the requestor is a workstation application rather than a DICOM service. Interactive tasks are placed onto the queue at a higher priority than the batch processing tasks that originate from the DICOM service. Each request has an associated priority and a time (the time it is put on the queue), as well as a packet of information that describes the processing being requested. The queue is maintained in sorted order—sorted first by priority, and second by the time an item was added to the queue. The algorithm service retrieves items from the queue in order—from the top, progressing to the bottom of the queue. Thus the earliest item of the highest priority is processed first, followed by the second item of the highest priority, and so on through time and priority. In this way, the interactive tasks are executed immediately, providing rapid response to the workstation application.

Periodically, even when a task is computing, the algorithm service checks for higher priority tasks that are waiting to be executed. If such a task is found on the queue (i.e., it is a new request), then this new request can pre-empt an already executing task. This is achieved by suspending the thread executing the existing task, and dispatching the new high priority task to a separate computation engine. The suspended task is resumed once the high priority task has completed.

The infrastructure introduces the following innovations to this domain:

Processing requests come from either a DICOM service for batch processing, or from a workstation application for interactive processing, with the requests differentiated by their relative priority.

Dispatch of algorithm processing as each image of a case is received,

Multiple processing streams in a single algorithm service.

These innovations result in the following benefits:

A single CAD infrastructure can support the needs of both batch and interactive processing, which means that the code for both can be centralized and shared between uses.

Minimal lag in the processing—since the images in a case are processed as received, if the algorithm processing occurs within the time of a single image transfer, then the worst case delay before a report is available is the time to process a single image. The typical model is to consider each case (e.g., containing 4 images in a mammography exam, or 200-500 images in a CT exam) as a single unit, with the result that the CAD processing does not start until the last image is received (so for example, this would mean a delay before report availability of 4× the time to process a single image in a typical screening mammography case). This feature of the system is most important for so-called “wet read” scenarios, where the patient is scanned, the images run through the processing, and the radiologist performs the read while the patient is still present. Of course many screening sites use a batch model, where the reading is deferred to a single session, but for sites that do immediate reading, CAD can only be useful if it is available at the same time as the images (of very shortly after them). Thus this feature is vital to making CAD usable in this reading model.

The trend in computing is more cores (CPUs) on single chip, and larger memories. Even a basic desktop system now typically has 2 cores, and 1 GB of memory is considered minimal. Desktop machines with 4 and even 8 cores are available this year, and it is quite common to have 8 GB of RAM on such a system. Even disk technology is undergoing a transformation, with the move to solid state (e.g., flash memory) drives. In order to take advantage of this evolution in the computing environment, the typical approach is to utilize threads to spread computational load across CPUs. The model here is to do this at two levels—the low level being the splitting of image processing tasks into bands that are assigned to different worker threads. This affords some speedup to a single operation, but for a complex sequence of operations that make up a large algorithm like mammography CAD, it has limited benefit (many of the steps in the processing cannot easily or productively utilize multiple threads, and there are many points requiring synchronization across threads). The second model employed in this new architecture is support for multiple processing streams within the algorithm service. The idea with this is that multiple cases can productively be processed in parallel within an algorithm service. This means that the throughput of the system can scale with the number of cores. A particular benefit of this design is that since multiple streams are sharing the memory, CPU and I/O resources of a single (multi-core) computer, the average usage of any of those resources tends to be lower than the sum of the peaks, because any algorithm instance cyclically uses those resources. In this new design, a single algorithm service maintains a pool of threads, a pool of execution engines (each capable of running an algorithm instance), and a pool of memory. These resources are shared across multiple jobs; with the benefit that the system can processes more jobs per hour than a system that supports only a single processing stream. This advance will of course be most useful at sites with heavy throughput needs (e.g., a site with multiple digital acquisition devices, with a single computer performing CAD for all of them)—so the advantages to the end user are lower cost and simplified configuration.

1. A system for optimal scheduling of image processing jobs, comprises:
an algorithm service; and
a requestor of CAD processing; and
a queue of jobs waiting to be processed; and
a queue of results from jobs that have been processed.

2. The system of claim 1, wherein the algorithm service, comprises:
a host of off-line batch algorithm preprocessing tasks; and
a host of online on-demand algorithm processing tasks.

3. The system of claim 1, wherein the requestor is a DICOM service, which in turn, comprises:
a means to receive images pushed to the system; and
a means to add requests to the processing queue at a low priority; and
a means to receive processed jobs from the completed queue; and
a means to generate DICOM structured reports from the algorithm results for a case.

4. The system of claim 1, wherein the requestor is a workstation application, which in turn comprises:
a means to add requests to the processing queue with a high priority; and
a means to receive processed jobs from the completed queue.
